(19) United States
(12) Patent Application Publication
(10) Pub. No.: US 2005/0238048 A1
(43) Pub. Date: Oct. 27, 2005

(54) Methods, systems, and computer program products for providing triggerless mobile services

(75) Inventors: Robert J. Delaney, Raleigh, NC (US); Todd Eichler, Wake Forest, NC (US)

Correspondence Address: JENKINS, WILSON & TAYLOR, P. A., 3100 TOWER BLVD, SUITE 1400, DURHAM, NC, 27707, US

(73) Assignee: Tekelec

(21) Appl. No.: 11/106,057

(22) Filed: Apr. 14, 2005

Related U.S. Application Data
(60) Provisional application No. 60/562,002, filed on Apr. 14, 2004.

(51) Int. Cl. H04J 3/16; H04J 3/22; H04L 12/56; H04L 12/28; H04L 12/66

(52) U.S. Cl. 370/466; 370/400

(57) ABSTRACT

Methods, systems, and computer program products for providing triggerless mobile services are disclosed. According to one method, a mobility management message is sent route-on-point code-subsystem number is received at a network node. The mobile management message includes an MTP destination point code that is not equal to the point code of the receiving node. The mobility management message is identified as a candidate for global title translation service. The mobility management message is analyzed to determine whether the SCCP portion contains global title data. If the SCCP portion does not contain global title data, global title data is derived from a TCAP portion of the message. GTT is performed based on the derived global title data and a point code of a first mobile services node is identified. The MTP DPC in the mobility management message is replaced with a point code of the mobile services node and the message is routed to the mobile services node.

### RELATED APPLICATIONS

This application claims the benefit of U.S. Provisional Patent Application Ser. No. 60/562,002, filed Apr. 14, 2004; the disclosure of which is incorporated herein by reference in its entirety.

### TECHNICAL FIELD

The subject matter described herein relates to routing messages in a mobile communications network. More particularly, the subject matter described herein relates to methods, systems, and computer program products for providing triggerless mobile services in a communications network.

### BACKGROUND ART

In mobile communications networks, signaling messages, such as mobility management messages, are sent to or from mobile switching centers (MSCs), home location registers (HLRs), visitor location registers (VLRs), equipment identity registers (EIRs), authentication centers (AuCs), home subscriber servers (HSSs), and short message service centers (SMSCs). Because sending nodes lack address information regarding destinations, mobility management messages are typically sent route-on-global title (route-on-gt). Route-on-gt means that the sending node sets a signaling connection control part (SCCP) parameter in the message to indicate that the global title translation (GTT) is required before the message can be routed to its intended destination.

Global title translation is typically performed at an intermediate node, such as an STP. One STP marketed by the assignee of the present invention as the Eagle® STP includes SCCP cards that perform global title translation for received signaling messages. Signaling messages received by the STP are identified as route-on-gt and forwarded an SCCP card, referred to as a database services module (DSM), where GTT is performed. At the SCCP card, the message may be global title translated using standard global title translation tables. Alternatively, if the message requires a specialized type of global title translation, alternate tables may be accessed.

One specialized SCCP application marketed by the assignee of the present invention as G-Flex™ or G-Flex™ Message Relay, performs a lookup in a first database using the SCCP called party address. The first database may contain global title translation rules that are exceptions to rules in the standard GTT database. If a lookup in the first database results in a match, the message is global title translated using the entry in the first database and routed to its intended destination. If the lookup in the first database fails to locate a match, a lookup is performed in the GTT database, and the message is routed based on the results of the GTT translation.

Currently, G-Flex™ and other wireless database applications assume that mobility management messages are sent route-on-gt. That is, many wireless database applications require that messages be sent route-on-gt in order for the application to be triggered. As used herein, the term “mobility management message” is intended to include any signaling message relating to providing mobile telecommunications service to a mobile subscriber, include messages sent to or from a mobile services node, such as an HLR, a VLR, an EIR, an AuC, an HSS, or an SMSC. Relying on GTT to route mobility management messages to their destinations is sufficient for GSM networks where the mobility management messages are sent route-on-gt. However, other types of mobility management messages, such as IS-41 mobility management messages, are typically sent route-on-pc-ssn (MTP routed) where the DPC in each message is not set to the point code of the STP. Rather, the DPC is set to the point code of another node (e.g., the HLR). Therefore, GTT and other applications that assume the message is sent route-on-gt are ineffective for IS-41 networks. In addition, applications triggered by global title routed messages are bypassed.

FIG. 1 illustrates a conventional mobile communications network in which IS-41 messages must be routed to the point codes of the destination nodes. In FIG. 1, it is assumed that a first operator owns end offices 100, 102, 104, and 106, and a second operator owns STPs 108 and 110. It is assumed that a third operator owns STPs 112 and 114, and a fourth operator owns and SCPs 116, 118, and 120. The IS-41 network operator owning the STP pair 108 and 110 having point codes 1-1-1 and 1-1-2 has roaming agreements with the operator who owns STP pair 112 and 114 having point codes 11-5-10 and 11-3-10. The operator who owns STP pair 108 and 110 subsequently connects to various networks (244 and 5) as shown in FIG. 1. Since mobility management messages are MTP routed in IS-41, the operator who owns SSP 106 having the point code 5-2-1 must know the point code and subsystem of the HLR that contains the mobile subscriber information (e.g., for authentication). This is extremely undesirable as most operators do not want to broadcast their point codes outside of their own networks but typically have no choice in roaming agreements in IS-41 networks. In addition, relying on point code routing makes moving subscribers between HLRs or other mobile services nodes very difficult as all roaming partners must simultaneously change translation tables at the MSCs to point to the new HLR.

Accordingly, in light of the reliance of conventional networks of routing mobility management messages based on global title translation, there exists a need for improved methods, systems, and computer program products for routing mobility management messages sent route-on-point-code-subsystem-number.

### DISCLOSURE OF THE INVENTION

According to one aspect, the subject matter described herein includes a method for intercepting and redirecting mobility management messages sent route-on-point-code-subsystem-number. According to the method, a mobility management message sent route-on-point-code-subsystem-number is received. The mobility management message includes a message transfer part (MTP) destination point code (DPC) that is not equal to a point code of the receiving node. Even though the message is sent route-on-point-code-subsystem-number, the message is identified as a candidate for global title translation service. It is determined whether the SCCP portion of the message contains global title data. If the SCCP portion of the message does not contain GTT data, global title data is derived from a TCAP portion of the message. GTT is performed based on the derived global title data from the TCAP portion of the message. GTT is performed based on the derived global title data and a point code of mobile services node is determined. The MTP DPC in the mobility management message is replaced with the point code of the mobile services node. The message is then MTP routed to the mobile services node.

According to another aspect of the subject matter described herein, a signaling message routing node includes a first module for receiving a mobility management message sent route-on-point-code-subsystem-number. The mobility management message is MTP addressed to a point code other than a point code of the signaling message routing node. The signaling message is identified as a candidate for GTT service. It is also determined whether the SCCP portion of the message includes global title data. A second module receives the mobility management message and, if the SCCP portion of the message does not include GTT data, the second module derives global title data from a TCAP portion of the message. The second module performs GTT based on the derived global title data and determines a point code corresponding to a mobile services node. The MTP DPC in the message is replaced with a point code, and the message is routed to the mobile services node.

The methods and systems described herein for providing triggerless mobile services can be implemented in hardware, software, firmware, or any combination thereof. According to one aspect, the subject matter described herein can be implemented using a computer program product comprising computer executable instructions embodied in a computer readable medium. Exemplary computer readable media suitable for implementing the subject matter described herein include chip memory devices, optical or magnetic disk memory devices, downloadable electrical signals, programmable logic devices, or any other device capable of storing computer executable instructions.

### BRIEF DESCRIPTION OF THE DRAWINGS

Preferred embodiments of the subject matter described herein will now be explained with reference to the accompanying drawings of which:

FIG. 1 is a network diagram illustrating conventional routing of mobility management messages;

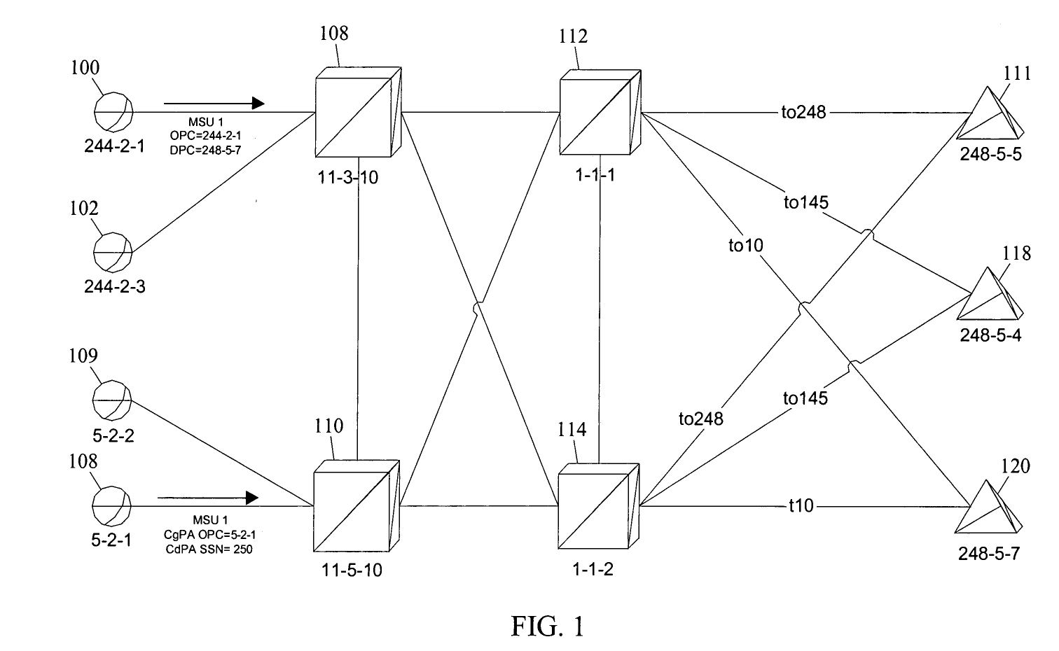

FIG. 2 is a block diagram of a triggerless mobile services node that routes message sent route-on-point-code-subsystem-number to HLRs according to an embodiment of the subject matter described herein;

FIG. 3 is a flow chart illustrating exemplary steps for routing mobility management messages sent route-on-point code-subsystem number according to an embodiment of the subject matter described herein; and

FIG. 4 is a block diagram illustrating an exemplary internal architecture for a triggerless mobile services node according to an embodiment of the subject matter described herein.

### DETAILED DESCRIPTION OF THE INVENTION

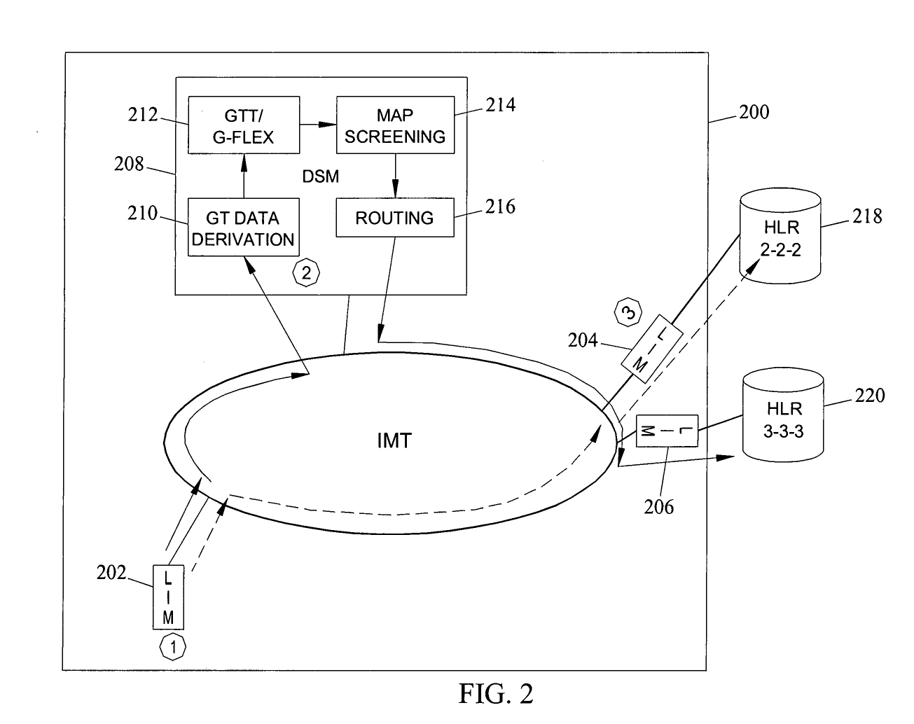

As described above, the subject matter described herein includes methods and systems for providing triggerless mobile services. By “triggerless mobile services,” it is meant that mobile services, such as routing messages to HLRs, AuCs, EIRs, HSSs, or SMSCs or other services triggered by GT-routed messages, may be performed without requiring that the messages be addressed to the point code of an intermediate node that provides the services or that the messages be sent route-on-gt. FIG. 2 is a block diagram of a routing node for providing triggerless mobile services according to an embodiment of the subject matter described herein. In FIG. 2, routing node 200 includes link interface modules (LIMs) 202, 204, and 206 and a database services module (DSM) 208 for providing triggerless mobile services. In the illustrated example, database services module 208 includes a global title data derivation function 210, a GTT/G-Flex function 212, a mobile application part (MAP) screening function 214, and a routing function 216. Routing node 200 is connected to HLRs 218 and 220.

FIG. 2 illustrates two exemplary message flows. In the message flow indicated by the solid arrows and marked by indicators 1-3, a message is first perceived at LIM 202. The message is MTP routed and is assumed not to be addressed to the point code of routing node 200. At LIM 202, the destination point code (DPC), the service indicator (SI), and/or the originating point code (OPC) in the message may be analyzed. In particular, if the DPC is determined to be a DPC associated with one of HLRs 218 and 220 or other mobile services node, and the message is determined to be an SCCP message, the message may be redirected to DSM 208. The OPC may be analyzed to determine whether the message is from a mobile services node, as an additional criteria for routing the message to DSM 208.

The global title indicator (GTI) may also be analyzed at LIM 202 to determine how GTT will be performed. If the global title indicator indicates that the SCCP portion contains global title information, a first flag may be set in the message to indicate to DSM 208 that GTT is to be performed using the global title information in the SCCP portion of the message, even though the message is not addressed to the point code of routing node 200. If the message is determined not to have global title information in the SCCP portion (i.e., GTI=0), the message is preferably tagged with second that indicates to DSM 208 that the TCAP/MAP portion of the message must be decoded to derive global title information.

In this example, it is assumed that global title data derivation is required. Accordingly, at step 2 in the message flow of FIG. 2, the message is forwarded to DSM 208, and global title data derivation is required. IS-41 mobility management messages may be one type of message for which global title data derivation is required because such messages cannot have any global title information other than a point code and subsystem number in the SCCP CdPA, and CgPA fields. Thus, dialed digits or the mobile identification number (MIN) must be extracted from the transaction capabilities application part (TCAP) layer so that GTT can be performed. An associated translation type (TT) may also be derived based on the TCAP or mobile application part (MAP) opcode. In one example, if the MAP opcode indicates that the message is an IS-41 registration notification message, the TT may be set to a value that indicates that the message is destined for an HLR. The derived global title data may be placed in the SCCP called party address field of the message.

Once the SCCP portion of the message is modified to include the GT address and translation type, the message is forwarded to GTT/G-Flex process 212. GTT/G-Flex process 212 performs a lookup in a translation table and determines a point code of the destination. The point code is inserted in the MTP portion of the message.

After GTT or G-Flex processing is performed message may optionally be forwarded to MAP screening process 214. MAP screening process 214 screens predetermined types of MAP messages to determine whether to allow the message in the network. Exemplary MAP screening functions are described in detail in commonly assigned, co-pending U.S. Patent Application Publication No. US-2001-0046856-A1, published Nov. 29, 2001, the disclosure of which is incorporated herein in its entirety. Briefly, MAP screening includes analyzing the MAP portion of the message and screening predetermined MAP message types. Such screening is useful in preventing certain types of MAP messages from entering or being routed through a network.

Assuming that the message passes MAP screening, the message is forwarded to routing function 216 where the message is routed to the link interface module, in this case, LIM 206, associated with the outbound signaling link. Link interface module 206 forwards the message to HLR 220.

Using the message flow illustrated in FIG. 2, messages that are sent route-on-point-code-subsystem-number to a point code other than that of an intermediate node that performs GTT can be properly routed to the correct destination. Such functionality may be useful in mobile communications network in which messages are not sent route-on-global-title and in which it is not desirable to modify each MSC's translation tables each time a new mobile services node is added to the network.

The message flow indicated by the solid arrows in FIG. 2 can be contrasted with the message flow indicated by the dashed arrows. As indicated by the dashed arrows in FIG. 2, if a message arrives at routing node 200 and is addressed to HLR 218, without the subject matter described herein, the message would be routed to HLR 218, bypassing GTT or other advanced routing services. Thus, when an operator adds a new HLR to the network, it would be necessary to modify either every end office switch or MSC in the network to route certain messages to the new HLR or to send message route-on-global-title. The subject matter described herein reduces the need for the operator to perform either of these functions.

In the example presented in FIG. 2, it should be noted that the final node receiving the message may be different from the original DPC. This also means that the response to the originator may come from a different point code than the original DPC. This should not be an issue in most networks, since most MSCs allow for a range of point codes from which a response is acceptable. It should also be noted that most transactions involving mobility management messages are not transaction oriented.

In addition, unlike conventional GTT, the OPC in the routing label of the outbound message may not be changed to the point code of routing node 200. This ensures that the response will be sent to the appropriate destination.

Another advantage of the scenario illustrated in FIG. 2 is that messages that are sent rout-on-global-title may be processed by advanced mobile services applications, such as MAP screening application 214. Allowing MTP routed messages to access advanced SCCP functions can enhance security, billing, or any other advances services that a network service provider wishes to provide.

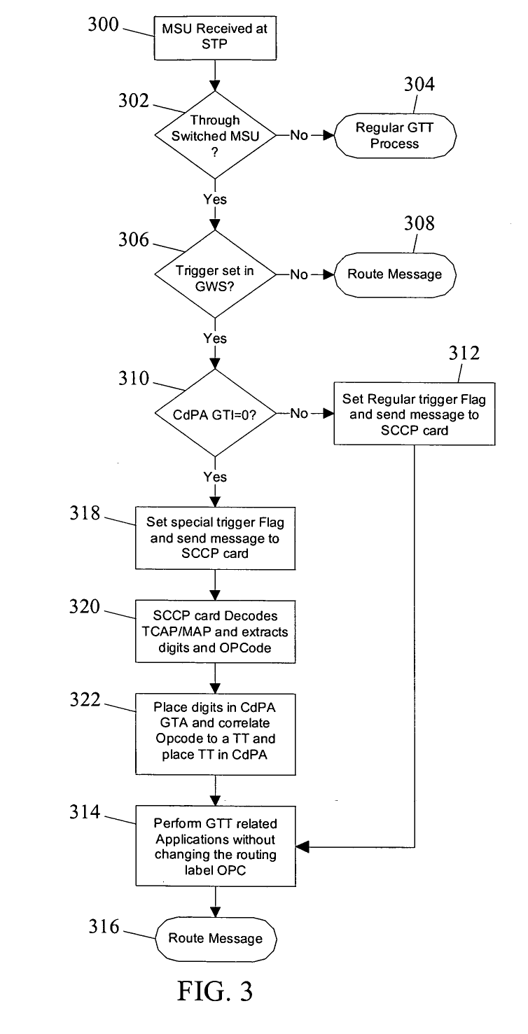

FIG. 3 is a flow chart illustrating exemplary steps for providing triggerless mobile services according to an embodiment of the subject matter described herein. The steps illustrated in FIG. 3 may be implemented by routing node 200 illustrated in FIG. 2. Referring to FIG. 3, in step 300, a message is received at routing node 200. In step 302, it is determined whether the message is a through-switched message. Determining whether the message is a through-switched message may include analyzing a destination point code in the message. If the destination point code is set to the point code of routing node 200, the message is determined not to be a through-switched message, and control proceeds to step 304 where normal GTT processing is performed.

If, on the other hand, the message is determined to be a through-switched message, control proceeds to step 306 where it is determined whether a trigger is set by gateway screening. As will be described in more detail below, gateway screening is a process performed on the inbound link interface module to determine whether a message should be allowed into the network. According to the subject matter described herein, special triggers may be set in gateway screening to determine whether the message is a mobility management message. If the message does not match a gateway screening trigger, control proceeds to step 308 where the message is routed.

If the message does match a gateway screening trigger, control proceeds to step 310 where it is determined whether the called party global title indicator is equal to 0. If the called party global title indicator is not equal to 0, the SCCP portion of the message may include global title information. Accordingly, control proceeds to step 312 where a regular trigger flag is set in the message (indicating that GTT should be performed based on SCCP data), and the message is forwarded to the SCCP card. Control then proceeds to step 314 where GTT and related processing is performed on the message and the message is routed, preferably without changing the routing label OPC.

In step 310, if the called party global title indicator is equal to 0, this means that the SCCP portion of the message does not contain any global title information. If the SCCP does not contain any global title information, control proceeds to step 316 where a special trigger flag is set and the message is sent to the SCCP card. The special trigger flag may indicate to the SCCP card that the message requires global title data derivation. In step 318, the SCCP card decodes the TCAP/MAP portion of the message and extracts the dialed digits and the op code. In step 320, the SCCP card places the digits in the called party address of the message. The opcode is preferably correlated to a translation type. The translation type is preferably placed in the called party address field of the message. Control then proceeds to step 314 where GTT and related applications are performed. Control then returns to step 316 where the message is routed to its intended destination.

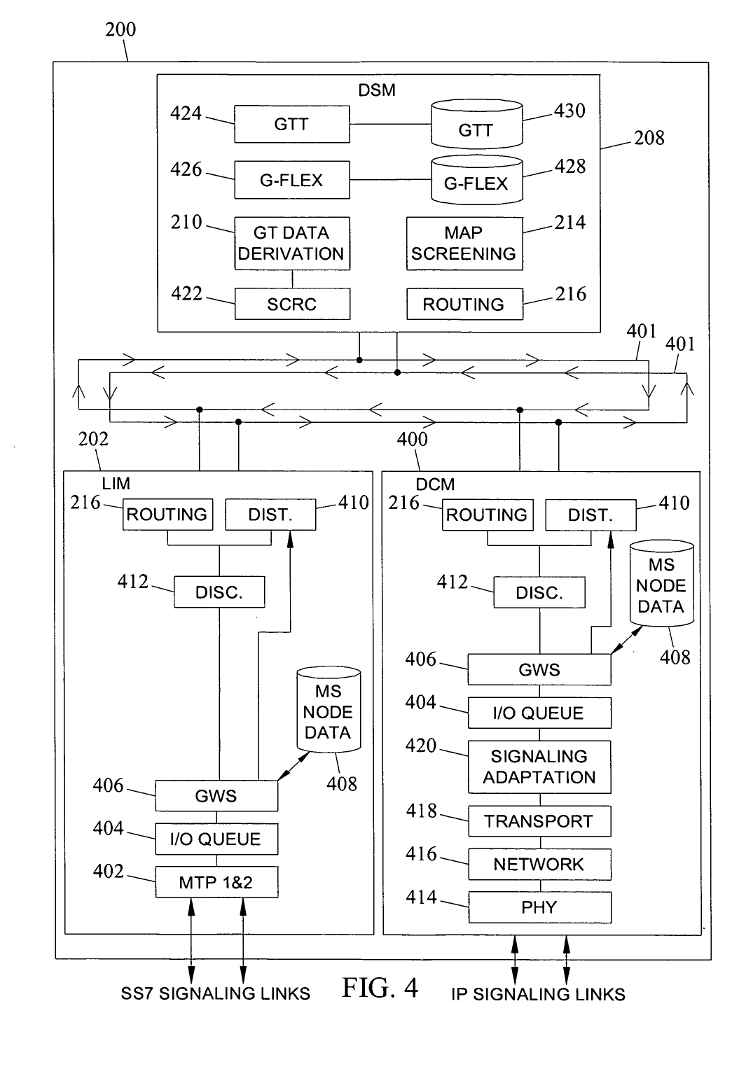

FIG. 4 is a block diagram illustrating an exemplary internal architecture for routing node 200 in more detail. Routing node 200 may include an underlying hardware and software platform that implements STP functions, including MTP routing and GTT functions, SS7/IP gateway functions, including routing IP and SS7 messages and converting between SS7 and IP, and/or session initiation protocol (SIP)/SS7 gateway (SSG) functions, including routing SIP and SS7 messages and converting between SIP and SS7 protocols. Any exemplary underlying hardware and software platform suitable for implementing the subject matter described herein includes the above-referenced Eagle® STP platform with an associated G-Flex database.

As described above, the G-Flex database may include entries or translations that are exceptions to the entries in the GTT database. For example, entries in the GTT database may be indexed by ranges of mobile subscriber identifiers. The G-Flex database may include entries that are indexed by individual mobile subscriber identifiers that are inside of the ranges of mobile subscriber identifiers by which entries in the GTT database are indexed. In addition or in the alternative, the G-Flex database may include entries that are indexed by individual mobile subscriber identifiers that are outside of the ranges of mobile subscriber identifiers by which entries in the GTT database are indexed. Further details regarding G-Flex processing can be found in commonly-assigned U.S. Pat. No. 6,836,477.

In FIG. 4, routing node 200 includes LIM 202, DSM 208, and data communications module (DCM) 400. For simplicity of illustration, LIMs 204 and 206 have been omitted. Each of the modules illustrated in FIG. 4 may include a printed circuit board having an application processor and a communications processor mounted thereon. The application processor may implement signaling protocol functions, such as SS7 routing, IP routing, and GTT, depending on the module type. The communications processor may control communications between modules via inter-processor communications subsystem 401. Inter-processor communications subsystem 401 may be implemented using a counter-rotating, dual-ring bus. In an alternate implementation, inter-processor communications subsystem 401 may be implemented using a local area network, such as an Ethernet.

In the illustrated example, LIM 202 includes functionality for sending and receiving SS7 signaling message via SS7 signaling links. An MTP level 1 and 2 function 402 performs MTP level 1 and 2 functions, such as error detection, error correction, and sequencing of SS7 signaling messages. An I/O queue 404 stores inbound and outbound signaling messages before they can be processed by higher or lower layers. A gateway screening function 406 screens signaling messages based on OPC, DPC, and SI parameters to determine whether to allow messages into the network. In addition, gateway screening function 406 may access mobile services node data 408 to determine whether a message is a mobility management message that is sent route-on-point-code-subsystem-number according to an embodiment of the subject matter described herein. For such messages, gateway screening function 406 may forward the messages directly to a distribution function 410 for distribution to DSM 208.

For messages that are not mobile services messages that are sent route-on-point-code-subsystem-number, gateway screening function 406 may forward the messages to discrimination function 412. Discrimination function 412 may analyze the destination point code in the message and determine whether the message is addressed to the point code of routing node 200 or to another point code. For messages addressed to the point code of routing node 200, discrimination function 412 may forward the messages to distribution function 410. Distribution function 410 may distribute the message to an internal processing module, such as DSM 208, for internal processing.

For messages that are not addressed to the point code of routing node 200, discrimination function 412 may forward the messages to routing function 216. Routing function 216 routes the messages to the interface module associated with the outbound signaling link. However, as stated above, predetermined messages, such as mobility management message, that are not addressed to the point code of routing node 200 may bypass discrimination function 412 and routing function 216 and be forwarded automatically to DSM 208.

DCM 400 performs functions similar to LIM 202 for sending and receiving signaling messages over IP signaling links. In the illustrated example, DCM 400 includes a physical layer function 414, a network layer function 416, and an SS7 adaptation layer function 418. Physical layer function 414 may control the sending and receiving signaling messages over IP signaling links. In one exemplary implementation, physical layer function 414 may be implemented using an Ethernet transceiver. Network layer function 416 performs network layer functions for signaling messages. Network layer function 416 may be implemented using Internet protocol. Transport layer function 418 may perform transport layer functions, such as setting up connections between endpoints. In one example, transport layer function 418 may be implemented using stream control transmission protocol (SCTP). In an alternate implementation, transport layer function 418 may be implemented using transmission control protocol (TCP) or user datagram protocol (UDP). Signaling adaptation layer 420 may perform functions for sending and receiving signaling messages over IP signaling links. Signaling adaptation layer 420 may be implemented using M3UA, M2PA, SUA, TALI, or other suitable adaptation layer protocol. The remaining functions of DCM 400 are the same as those of LIM 202. Hence, a description thereof will not be repeated herein.

Database services module 208 includes functions for providing SCCP layer services. In the illustrated, example DSM 208 includes a signaling connection routing controller (SCRC) 422 for identifying the type of service required for a received message. SCRC 422 may analyze the GTI or special flag set by LIM 202 to identify whether global title data derivation is required. If global title data derivation is required, SCRC 422 may forward the message to global title data derivation function 210. Global title data derivation function 210 derives global title translation data from the TCAP/MAP portion of the message as described above. Global title data derivation function 210 may then forward the message to either GTT function 424 or G-Flex function 426. Determining whether a message should be forwarded to GTT function 424 or G-Flex function 426 may include forming a compound key based on parameters in the message including TT, subsystem number, global title indicator, nature of address indicator, or other parameters. If the message is identified as requiring G-Flex service, the message is forwarded to G-Flex function 426. G-Flex function 426 performs a lookup based on the SCCP called party address in G-Flex database 428.

If the result of the lookup in G-Flex database 428 results in a match, the destination point code in the message is replaced with that extracted from G-Flex database 428. The message is then forwarded to routing function 216 for routing. Additional SCCP layer functions, such as MAP screening function 214, may also process the message before it is routed.

If the message is indicated as requiring GTT service only or if the lookup in G-Flex database 428 fails, GTT function 424 performs a lookup in GTT database 430. The result of the lookup in GTT database 430 is a point code corresponding to the destination. This point code is inserted in the MTP routing label of the message and the message is routed by routing function 216. In addition, advanced mobile services, such as those provided by MAP screening function 214, may be applied.

Routing function 216 may route the message to the interface module associated with the destination signaling link. If the destination signaling link is an SS7 signaling link, routing function 216 may route the message to the link interface module associated with the SS7 signaling link. If the destination is an IP signaling link, routing function 216 may route the message to the data communications module associated with the IP signaling link. For SS7 messages destined for IP signaling links, the DCM may encapsulate the messages in SS7 adaptation layer, transport layer, network layer, and physical layer packets before sending the message to the destination node. If the destination node is a SIP-enabled node, such as an HSS, the DCM may convert the SS7 message into a SIP message including the mobility management information and forward the SIP message to the HSS over the IP network.

Thus, as described above, the subject matter described herein includes methods, systems, and computers program products for providing triggerless mobile services. The triggerless mobile services may be provided for mobility management messages that are not addressed to the point code of an intermediate node and that are not sent route-on-global-title. As a result, messages in networks that do not use global title routing, such as IS-41 networks, may be routed to alternate destinations without requiring modification to sending nodes. In addition, advanced mobile services conventionally triggered by gt-routed messages may be provided for non-gt-routed messages.

It will be understood that various details of the invention may be changed without departing from the scope of the invention. Furthermore, the foregoing description is for the purpose of illustration only, and not for the purpose of limitation, as the invention is defined by the claims as set forth hereinafter.

1. A method for intercepting and redirecting mobility management messages sent route-on-point-code-subsystem-number, the method comprising:
at a network node:
(a) receiving a mobility management message sent route-on-point-code-subsystem-number, the mobility management message including a message transfer part (MTP) destination point code (DPC) that is not equal to a point code of the network node;
(b) identifying the mobility management message as a candidate for a global title translation service;
(c) performing a global title translation for the mobility management message to determine a point code of a first mobile services node;
(d) replacing the MTP DPC in the mobility management message with the point code of the first mobile services node; and
(e) routing the mobility management message to the first mobile services node.

2. The method of claim 1 wherein receiving a mobility management message includes receiving an Interim Standard 41 (IS-41) mobility management message.

3. The method of claim 1 wherein receiving a mobility management message that includes an MTP DPC that is not equal to a point code of the network node includes receiving a mobility management message that includes a point code of a second mobile services node different from the point code of the first mobile services node.

4. The method of claim 1 wherein identifying the mobility management message as a candidate for global title translation service includes examining the MTP destination point code in the mobility management message to determine whether the destination point code corresponds to a point code of a mobile services node.

5. The method of claim 4 wherein identifying the mobility management message as a candidate for global title translation service includes examining a service indicator in the mobility management message.

6. The method of claim 1 wherein performing GTT for the mobility management message includes deriving global title data from a transaction capabilities application part (TCAP) portion of the message.

7. The method of claim 6 wherein deriving the global title data from a TCAP portion of the message includes extracting a mobile identification number (MIN) from a mobile application part (MAP) portion carried in the TCAP portion of the message.

8. The method of claim 6 wherein deriving global title data from the TCAP portion of the message includes translating an opcode in the message into a signaling connection control part (SCCP) translation type (TT).

9. The method of claim 8 comprising inserting the TT and the MIN into an SCCP called party address field of the mobility management message and wherein performing a global title translation includes performing the global title translation based on the data inserted in the SCCP called party address field.

10. The method of claim 1 wherein performing a global title translation for the mobility management message includes performing a lookup in a first data structure in which entries are indexed by individual mobile identification numbers and, in response to failing to locate a matching entry in the first data structure, performing a lookup in a second data structure in which entries are indexed by ranges of mobile identification numbers.

11. The method of claim 10 wherein at least one of the entries in the first data structure is indexed by a mobile identification number that is within a range of mobile identification numbers by which one of the entries in the second data structure is indexed.

12. The method of claim 10 wherein at least one of the entries in the first data structure is indexed by a mobile identification number that is outside of all of the ranges of mobile identification numbers by which entries in the second data structure are indexed.

13. The method of claim 1 wherein routing the mobility management message to the first mobile services node includes MTP routing the mobility management message to a home location register (HLR) in a network that includes multiple HLRs.

14. The method of claim 1 wherein routing the mobility management message to the first mobile services node includes routing the mobility management message to a node selecting from a group consisting of: home location registers (HLRs), visitor location registers (VLRs), authentication centers (AuCs), equipment identity registers (EIRs), home subscriber servers (HSSs), and short message service centers (SMSCs).

15. The method of claim 1 wherein routing the mobility management message to the first mobile services node includes encapsulating the mobility management message in an Internet protocol datagram and forwarding the IP-encapsulated mobility management message to the first mobile services node in an IP network.

16. The method of claim 1 wherein routing the mobility management to the first mobile services node includes converting the mobility management message to a session initiation protocol (SIP) message including mobility management information extracted from the mobility management message and forwarding the SIP message to the first mobile services node.

17. The method of claim 1 comprising performing at least one route-on-global-title-triggered service for the mobility management message.

18. The method of claim 17 wherein performing at least one route-on-global-title-triggered service includes performing mobile application part (MAP) screening for the mobility management message.

19. The method of claim 1 wherein performing steps (a)-(e) at a network node includes performing steps (a)-(e) at an SS7 signal transfer point.

20. A signaling message routing node comprising:
(a) a first module for receiving a mobility management message sent route-on-point-code-subsystem-number and that is message transfer part (MTP)-addressed to a point code other than a point code of the signaling message routing node and for identifying the mobility management message as a candidate for global title translation service;
(b) a second module for receiving the mobility management message, for performing a global title translation for the mobility management message to determine a first point code corresponding to a first mobile services node, and for replacing the MTP destination point code in the mobility management message with the point code corresponding to the first mobile services node; and
(c) a routing function for routing the mobility management message to the first mobile services node using on the first point code.

21. The signaling message routing node of claim 20 wherein the first module comprises an SS7 link interface module.

22. The signaling message routing node of claim 20 wherein the first module is adapted to examine an MTP destination point code and a service indicator in the mobility management message to identify the message as a candidate for global title translation service.

23. The signaling message routing node of claim 20 wherein the second module comprises a signaling connection control part (SCCP) module.

24. The signaling message routing node of claim 20 wherein the second module is adapted to derive global title data from the mobility management message by extracting a mobile identification number (MIN) from a mobile application part (MAP) portion of the message carried in a transaction capabilities application part (TCAP) portion of the message and translating an opcode in the message into an SCCP translation type (TT).

25. The signaling message routing node of claim 24 wherein the second module is adapted to insert the MIN and the TT in an SCCP called party address field of the message and to perform the global title translation based on the data stored in the SCCP called party address field.

26. The signaling message routing node of claim 20 wherein the second module is adapted to perform the global title translation by performing a lookup in a first data structure in which entries are indexed by individual mobile subscriber identifiers, and, in response to failing to locate a matching entry in the first data structure, the second module is adapted to perform a lookup in a second data structure in which entries are indexed by ranges of mobile subscriber identifiers.

27. The signaling message routing node of claim 26 wherein at least one of the entries in the first data structure is indexed by a mobile identification number that is within one of the ranges of mobile identification numbers by which entries in the second data structure are indexed.

28. The signaling message routing node of claim 26 wherein at least one of the entries in the first data structure is indexed by a mobile identification number that is outside of all of the ranges of mobile identification numbers by which entries in the second data structure are indexed.

29. The signaling message routing node of claim 20 wherein the routing function is adapted to route the mobility management message to a home location register (HLR) in a network that includes multiple HLRs.

30. The signaling message routing node of claim 20 wherein the routing function is adapted to route the mobility management message to a node selected from a group consisting of: a home location register (HLR), a visitor location register (VLR), an authentication center (AuC), an equipment identity register (EIR), a home subscriber server (HSS), and a short message service center (SMSC).

31. The signaling message routing node of claim 20 comprising a data communications module for receiving the mobility management message from the routing function, for encapsulating the mobility management message in an IP datagram, and for forwarding the IP-encapsulated mobility management message to the mobile services node in an IP network.

32. The signaling message routing node of claim 20 comprising a data communications module for receiving the mobility management message from the routing function, for converting the mobility management message to a session initiation protocol (SIP) message including mobility management information extracted from the mobility management message, and for forwarding the SIP message to the first mobile services node.

33. The signaling message routing node of claim 20 comprising at least one route-on-global-title-triggered function associated with the second communication module for providing at least one mobile service for the mobility management message.

34. The signaling message routing node of claim 20 wherein the at least one route-on-global-title-triggered function includes a mobile application part (MAP) screening function.

35. A computer program product comprising computer-executable instructions embodied in a computer-readable medium for performing steps comprising:
at a network node:
(a) receiving a mobility management message sent route-on-point-code-subsystem number, the mobility management message including a message transfer part (MTP) destination point code (DPC) that is not equal to a point code of the network node;
(b) identifying the mobility management message as a candidate for global title translation service;
(c) performing global title translation for the message to determine a point code of a mobile services node;
(d) replacing the MTP DPC in the mobility management message with the point code of the mobile services node; and
(e) routing the mobility management message to the mobile services node.
